(19) United States
(12) Patent Application Publication
(10) Pub. No.: US 2005/0270787 A1
(43) Pub. Date: Dec. 8, 2005

(54) Light

(76) Inventor: Thomas Gross, Eningen (DE)

Correspondence Address: KENYON & KENYON, ONE BROADWAY, NEW YORK, NY, 10004, US

(21) Appl. No.: 11/142,108

(22) Filed: May 31, 2005

(30) Foreign Application Priority Data
May 29, 2004 (DE) 10 2004 026 465.1

(51) Int. Cl. B29D 11/00

(52) U.S. Cl. 362/487

(57) ABSTRACT

A light, e.g., a tail light, for a motor vehicle, includes a lens which covers a housing opening in the beam direction of the light. The lens includes at least two lens sections, which are injection-molded onto each other along a connection region. The injection points of the respective lens sections are arranged in the connection region (5).

### CROSS-REFERENCE TO RELATED APPLICATIONS

The present application claims priority to Application No. 10 2004 026 465.1, filed in the Federal Republic of Germany on May 29, 2004, which is expressly incorporated herein in its entirety by reference thereto.

1. Field of the Invention

The present invention relates to a light, e.g., a tail light, for a motor vehicle.

2. Background Information

Conventional lights for motor vehicles, e.g., tail lights, normally have a lens, which covers a housing opening of the light in the beam direction. Such a lens may be made of plastic in the form of an injection-molded part. In this connection, the injection-molding, i.e., the manufacture of the lenses, may be implemented with the aid of a film sprue or a hot-channel sprue or with the aid of film injection molding or hot-channel injection molding. The injection-molding point is located on an outer edge of the lens and is filled through an elongated sprue. This elongated sprue must be machined, e.g., deburred, after the injection-molding operation and after removal of the injection-molded part from the injection-molding die, which generates additional costs.

In contrast to film injection molding, hot-channel injection molding usually takes place at the center of the lens. The injection-molding point is recognizable by thin cross hairs. It may be disadvantageous that, directly at the injection-molding point, optical inhomogeneities or streaks may be seen, and the temperature resistance of the cover-disk material may be simultaneously reduced. This may be unfavorable, when this injection-molding point is arranged in the line of or is aligned with the focal point of an incandescent light and a maximum temperature consequently occurs at it.

A method and a device for injection-molding one-color, two-color, or multicolor plastic parts is described in German Published Patent Application No. 198 58 183. In this context, the device has a matrix or die, two interchangeable cores, and sliders or slide bars. The first core initially used forms, together with the matrix, a first mold cavity for injection-molding the lighter, e.g., transparent, region in the form of a pre-molded part or blank. The second core that can be inserted next forms, together with the matrix and the premolded blank, a second mold cavity for the darker region of the plastic part and, in so doing, only contacts the premolded blank in a narrow, marginal strip about the second mold cavity. By this, the formation of eroded regions and the appearance of disturbing slider-bar marks may be reduced.

### SUMMARY

An example embodiment of the present invention may provide a light in which the above-mentioned disadvantages regarding the point of injection may be prevented.

In the case of a light, e.g., a tail light, for a motor vehicle, having a housing opening in the beam direction of the lens covering the light, an example embodiment of the present invention may provide production of a lens from at least two lens sections, which are injection-molded onto each other along a connection region.

The injection points of each lens section may be arranged in the connection region.

The injection points of each lens section may therefore be moved out of the region critical to the lighting function of the light and positioned at an edge region of each lens section nearly insignificant with regard to the optical function. Thus, streaks and/or material turbulence occurring at the injection point may no longer have an optical effect and, in this manner, may constitute almost no impairment to the lighting function. Furthermore, the need for expensive machining, e.g., expensive deburring, of the injection points may be eliminated, since in a finished headlight, these are now arranged in a region invisible from the outside. Therefore, an example embodiment of the present invention may improve the optical characteristics and simultaneously may allow time and cost advantages to be realized, due to machining no longer being necessary.

A clip and/or a cover or molding for optically separating the adjacent lens sections is or may be arranged in or on the connection region. In this manner, the connection region, in which each injection point of the adjacent lens sections is also arranged, may be covered by the molding so as to be invisible from the outside, which means that any streaks and/or material turbulence at the injection points may no longer be seen. The clip and/or the molding may be used as a design element, by which special designer effects may be achieved and, for example, different vehicle lines may be delimited from one another by using various clips and/or pieces of molding. To this end, it is possible that the molding and/or the clip is painted a vehicle color or is chromium-plated. Thus, e.g., lights of the higher class may have a chromium-plated clip and molding painted a vehicle color, whereas in the case of a vehicle line that is of a lower class with regard to price, both the molding and the clip may be painted vehicle colors.

According to an example embodiment of the present invention, the connection region may form an at least less transparent or translucent boundary between two lens sections injection-molded to each other. This may nearly prevent light from being transmitted between two lens sections injection-molded to each other, which means that different and adjacent lens sections may be assigned different lighting functions, such as a back-up or reversing light and a brake light.

According to an example embodiment, the molding and/or the clip may be locked to the lens by a clip fastener, e.g., a releasable one. This may allow the molding and/or the clip to be detached from, or attached to, the lens in, e.g., a particularly simple and serviceable manner, which means that cost advantages and time advantages may be realized in the case of repair and/or maintenance. In addition, it may be possible for moldings and/or clips of different exemplary embodiments to be offered as aftermarket or replacement parts via the aftermarket, so that a vehicle owner may attach individual pieces of molding and/or clips to the lens by simply locking them in.

The clip and/or the molding may be positioned flush with an outer surface of the lens. This may allow the outer surface of the lens or the light to be in substantially true alignment, thereby providing a design advantage over conventional lenses. In order to terminate the clip or the molding flush with the outer surface of the lens, an example embodiment may allow for the connection region to be shifted inwardly. In addition to being able to provide a receptacle or holder for the molding or the clip, the connection-region kink consequently formed in the cross section of the lens may provide stiffening for the lens, which means that its ability to hold its shape may be increased.

According to an example embodiment of the present invention, a motor vehicle light includes a lens arranged to cover a housing opening in a beam direction of the light. The lens includes at least two lens sections injection-molded to each other along a connection region, and injection points of the lens sections are arranged in the connection region.

The light may be arranged as a tail light.

Each lens section may correspond to a different light function.

The connection region may be located inwardly with respect to an outer surface of the lens sections.

The light may include at least one of (a) a clip and (b) a molding positioned at the connection region and arranged to optically separate the lens sections.

The at least one of (a) the clip and (b) the molding may be one of (a) painted a vehicle color and (b) chrome-plated.

The connection region may form a translucent boundary between the lens sections.

The one of (a) the clip and (b) the molded may be at least one of (a) locked to the lens by a clip fastener and (b) bonded to the lens.

The light may include a clip fastener, and the molding may be locked to the clip by the clip fastener.

At least one of the lens sections may be an injection-molded plastic part.

The at least one of (a) the clip and (b) the molding may be flush with an outer surface of the lens.

According to an example embodiment of the present invention a motor vehicle light includes lens means for covering a housing opening in a beam direction of the light. The lens means includes at least two lens section means injection-molded to each other along a connection region, and injection points of the lens section means are arranged in the connection region.

According to an example embodiment of the present invention, a motor vehicle includes a light, which has: a housing having a housing opening; and a lens covering the housing opening in a beam direction of the light. The lens includes at least two lens sections injection-molded to each other along a connection region, and injection points of the lens sections are arranged in the connection region.

Additional features and aspects hereof are described below with reference to the appended Figures.

It should be understood that the aforementioned features and those described below may be used not only in the combinations specifically indicated but also in other combinations or alone without departing from the spirit and scope hereof.

Exemplary embodiments of the present invention are represented in the appended Figures and explained in detail in the following description, where the same reference numerals refer to the same, functionally identical, or similar component parts.

### BRIEF DESCRIPTION OF THE DRAWINGS

FIG. 1 is an elevational view of a light according to an example embodiment of the present invention.

FIG. 2 is a cross-sectional view of the light illustrated in FIG. 1.

FIG. 3 is an exploded view of the light including a clip and molding.

### DETAILED DESCRIPTION

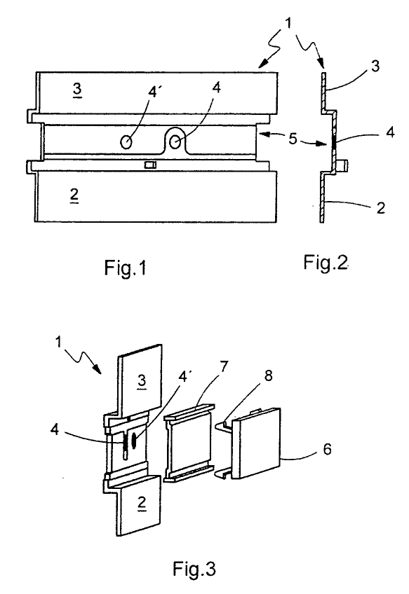

As illustrated in FIG. 1, a lens 1 of a light, e.g., a tail light for a motor vehicle, has at least two lens sections 2 and 3, which are each assigned to a separate lighting function, e.g., a brake light and a back-up light. In this context, lens 1 covers a housing opening of the light in the beam direction and may be manufactured as an injection-molded, plastic part, e.g., in a conventional manner. To produce the lens, lens sections 2, 3, which may have different colors, are injected into an injection-molding die, in that plastically deformable or moldable and hot plastic are injected through an injection point 4 into a die mold of the injection-molding die.

In this context, lens 1 is made up of at least two lens sections 2, 3, which are injection-molded onto each other along a connection region 5. It is also possible for lens 1 to have additional lens sections. As illustrated in FIG. 1, injection points 4, 4′ of respective lens sections 2, 3 are arranged in connection region 5.

Since injection points 4, 4′ may constitute weak points of the material, e.g., caused by material turbulence during the injection operation, and also may have to be subsequently machined if they are in a visible region or a region affecting the lighting function of light 1, an example embodiment of the present invention provides for them to be arranged in connection region 5 and, therefore, to not affect the lighting function of light 1. Furthermore, the additional and expensive deburring of injection points 4, 4′ may be eliminated, since they are arranged in region 5, which is subsequently covered by molding 6 and/or a clip 7.

Furthermore, the moving of injection points 4, 4′ out of the radiation region of light 1 may provide that the streaks usually occurring at injection point 4, 4′, which are produced, for example, by material turbulence during the injection operation, remain without being disadvantageous with regard to the quality of light 1. In addition, the robustness of light 1 may be increased, since the decreased temperature resistance of lens sections 2, 3 in the region of injection points 4, 4′ is subjected to a markedly lower temperature stress than in conventional lights having an injection point positioned centrally and in alignment with the focal point of the incandescent light.

Connection region 5 may form an at least less transparent boundary between two lens sections 2, 3 that are injection-molded onto each other or are adjacent, which means that adjacent lens sections 2, 3 may have, for example, different colors and different lighting functions, without the transmission of light across connection region 5 into adjacent lens section 3 or 2 affecting the adjacent lighting function.

As illustrated in FIG. 2, connection region 5 is shifted inwardly, and its cross section forms a U-shaped groove. As illustrated in FIG. 3, a piece of molding 6 and/or a clip 7 may be positioned in this U-shaped groove, e.g., in or on connection region 5, in order to optically separate adjacent lens sections 2 and 3. Depending on the arrangement, it may be provided that molding 6 and/or clip 7 is painted a vehicle color or is chromium-plated. By this arrangement, e.g., different vehicle lines may be classified according to design.

In order to attach or detach molding 6 and/or clip 7 simply and rapidly to or from lens 1, a clip fastener may be provided by which molding 6 and/or clip 7 is/are locked to lens 1. However, it is also possible for molding 6 and/or clip 7 to be additionally or alternatively bonded to lens 1. According to the example embodiment illustrated in FIG. 3, molding 6 has detents 8, which, e.g., reach through corresponding openings on clip 7 and lock into catch openings on lens 1, which are arranged to be complementary to detents 8.

In order to produce an outer surface of lens 1 that is as aesthetic as possible, clip 7 and/or molding 6 may terminate flush with an outer surface of the lens. A slightly protruding configuration of molding 6 or clip 7 or a configuration of the molding or the clip slightly recessed in connection region 5 is also possible.

The arrangement hereof may allow injection points 4, 4′ for respective lens sections 2, 3, which are adjacent and/or injection-molded onto each other, to be moved into connection region 5 and, in this manner, to not negatively affect the optical characteristics of the light. In addition, the positioning of injection points 4, 4′ in connection region 5, under clip 7 or molding 6, may provide that injection points 4, 4′ may not have to be subsequently machined in an expensive manner, e.g., after removing the injection-molded part from the die, which means that time advantages and cost advantages may be realized. In contrast to conventional lights, in which injection points 4, 4′ may be centrally positioned on lens 1 with respect to the lighting function, the design approach hereof may additionally provide that injection points 4, which are intrinsically more temperature sensitive, are no longer arranged in the direct illumination region of an incandescent light or a light source, and therefore, the temperature stress may be reduced.

In summary, features hereof include the following:

In the case of a light, e.g., a tail light of a motor vehicle, having a lens 1, lens 1 may be made of at least two lens sections 2, 3, which are injection-molded onto each other along a connection region 5. In this context, injection points 4, 4′ of respective lens sections 2, 3 are arranged in connection region 5 and, therefore, outside of a light region, which may be critical with respect to temperature or affects the lighting function. In addition, injection points 4, 4′ are covered by a clip 7 or molding 6 subsequently mounted to connection region 5 from the outside and are therefore no longer visible, which may eliminate the need for complicated and expensive machining.

1. A motor vehicle light, comprising:
a lens arranged to cover a housing opening in a beam direction of the light, the lens including at least two lens sections injection-molded to each other along a connection region, injection points of the lens sections arranged in the connection region.

2. The motor vehicle light according to claim 1, wherein the light is arranged as a tail light.

3. The motor vehicle light according to claim 1, wherein each lens section corresponds to a different light function.

4. The motor vehicle light according to claim 1, wherein the connection region is located inwardly with respect to an outer surface of the lens sections.

5. The motor vehicle light according to claim 1, further comprising at least one of (a) a clip and (b) a molding positioned at the connection region and arranged to optically separate the lens sections.

6. The motor vehicle light according to claim 5, wherein the at least one of (a) the clip and (b) the molding is one of (a) painted a vehicle color and (b) chrome-plated.

7. The motor vehicle light according to claim 1, wherein the connection region forms a translucent boundary between the lens sections.

8. The motor vehicle light according to claim 5, wherein the one of (a) the clip and (b) the molded is at least one of (a) locked to the lens by a clip fastener and (b) bonded to the lens.

9. The motor vehicle light according to claim 5, further comprising a clip fastener, the molding locked to the clip by the clip fastener.

10. The motor vehicle light according to claim 1, wherein at least one of the lens sections is an injection-molded plastic part.

11. The motor vehicle light according to claim 5, wherein the at least one of (a) the clip and (b) the molding is flush with an outer surface of the lens.

12. A motor vehicle light, comprising:
lens means for covering a housing opening in a beam direction of the light, the lens means including at least two lens section means injection-molded to each other along a connection region, injection points of the lens section means arranged in the connection region.

13. A motor vehicle, comprising:
a light including:
a housing having a housing opening; and
a lens covering the housing opening in a beam direction of the light, the lens including at least two lens sections injection-molded to each other along a connection region, injection points of the lens sections arranged in the connection region.
